(19) United States
(12) Patent Application Publication
(10) Pub. No.: US 2016/0185200 A1
(43) Pub. Date: Jun. 30, 2016

(54) Vehicle Protective Covering Assembly

(71) Applicant: Mike Molina, Helotes, TX (US)

(72) Inventor: Mike Molina, Helotes, TX (US)

(21) Appl. No.: 14/586,348

(22) Filed: Dec. 30, 2014

(51) Int. Cl. B60J 11/04

(52) U.S. Cl. CPC B60J 11/04

(57) ABSTRACT

A vehicle protective covering assembly includes a panel comprising a flexible material with a top side, a bottom side and a perimeter edge. The panel has a size to be positioned on a vehicle such that a first side section, a second side section, a top section, a front section and a rear section of the panel are defined. Each of the first and second side sections has an access door cut into the panel. A plurality of bladders is positioned between the top and bottom sides of the panel. The bladders are in fluid communication with each other and inflatable such that the top side of the panel is spaced from the bottom side a distance of at least 3.0 inches. The bladders substantially cover an entirety of the panel. A pump is in fluid communication with the bladders to fill the bladders with air.

### BACKGROUND OF THE DISCLOSURE

### Field of the Disclosure

The disclosure relates to vehicle body protection devices and more particularly pertains to a new vehicle body protection device for preventing damage to a vehicle during a hail storm.

### SUMMARY OF THE DISCLOSURE

An embodiment of the disclosure meets the needs presented above by generally comprising a panel comprising a flexible material with a top side, a bottom side and a perimeter edge. The panel has a size configured to be positioned on a vehicle such that a first side section, a second side section, a top section, a front section and a rear section of the panel are defined. Each of the first and second side sections has an access door cut into the panel wherein each the access door is formed by a flap portion of the panel. A plurality of bladders is positioned between the top and bottom sides of the panel. The bladders are elongated and are in fluid communication with each other. The bladders are inflatable such that the top side of the panel is spaced from the bottom side a distance of at least 3.0 inches. The bladders substantially cover an entirety of the panel. A pump is in fluid communication with the bladders to fill the bladders with air.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a vehicle protective covering assembly according to an embodiment of the disclosure.

FIG. 2 is a top view of an embodiment of the disclosure.

FIG. 3 is a side view of an embodiment of the disclosure.

FIG. 4 is a cross-sectional view of an embodiment of the disclosure taken along line 4-4 of FIG. 4.

FIG. 5 is a broken side view of an embodiment of the disclosure.

### DESCRIPTION OF THE PREFERRED EMBODIMENT

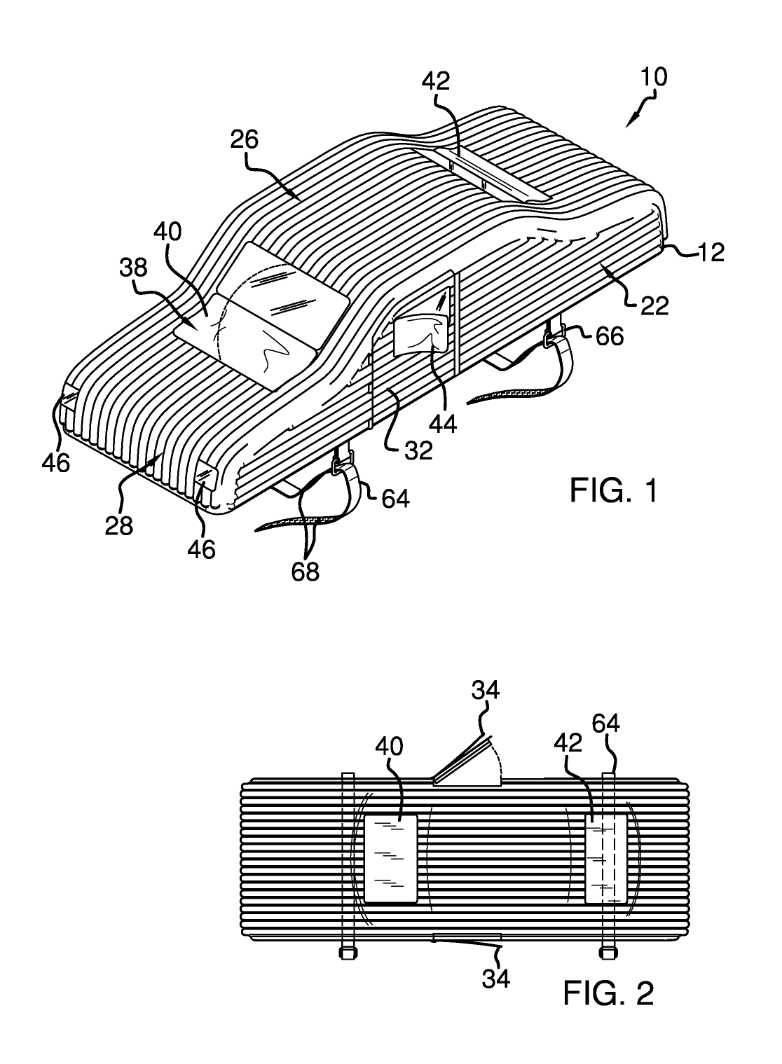

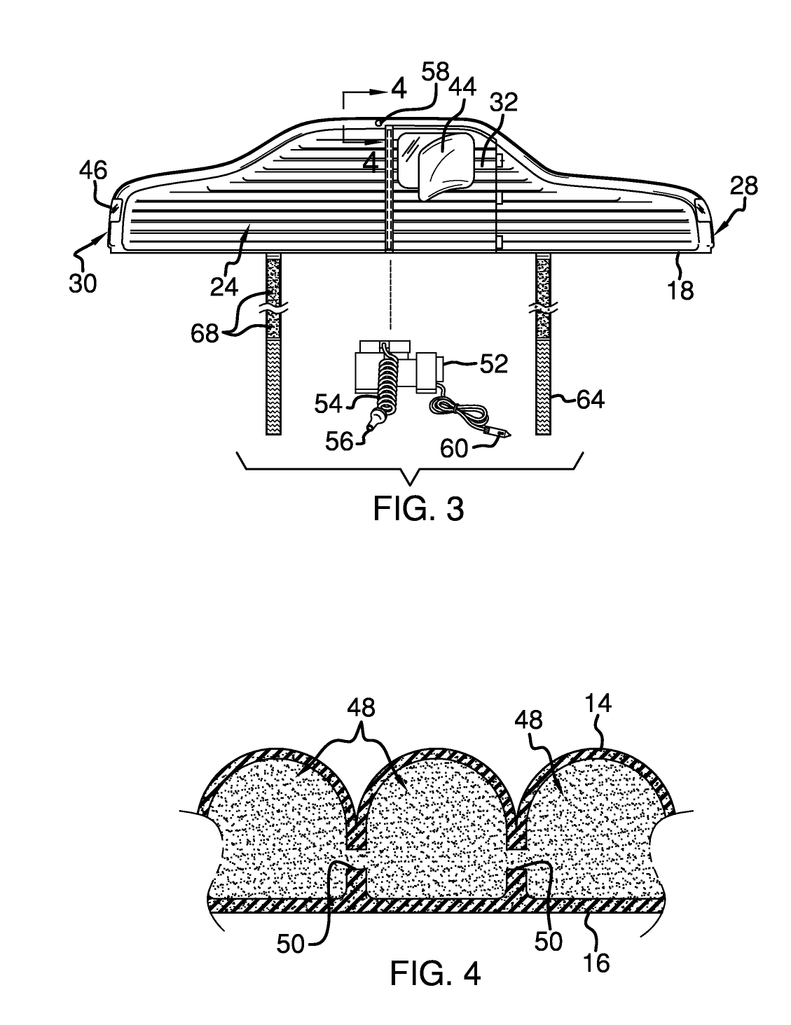

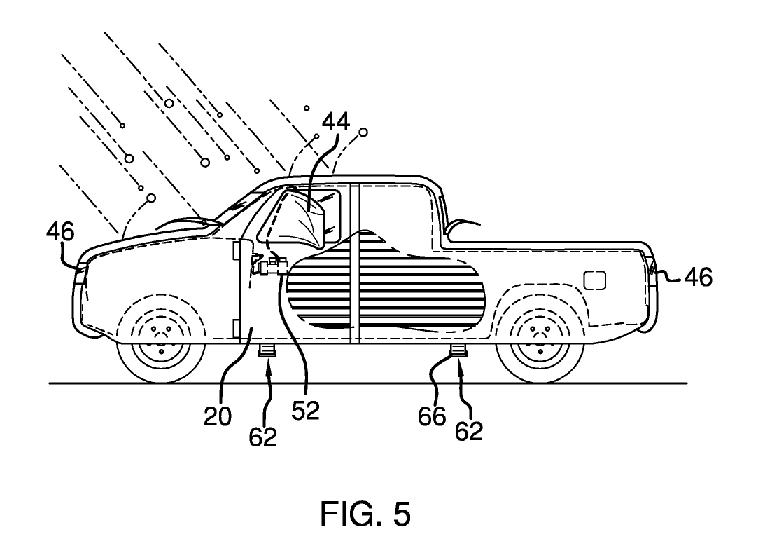

With reference now to the drawings, and in particular to FIGS. 1 through 5 thereof, a new vehicle body protection device embodying the principles and concepts of an embodiment of the disclosure and generally designated by the reference numeral 10 will be described.

As best illustrated in FIGS. 1 through 5, the vehicle protective covering assembly 10 generally comprises a panel 12 comprising a flexible material such as an elastomeric material. The panel 12 has a top side 14, a bottom side 16 and a perimeter edge 18. The panel 12 has a size configured to be positioned on a vehicle 20 such that a first side section 22, a second side section 24, a top section 26, a front section 28 and a rear section 30 of the panel 12 are defined. Generally, the panel 12 will be sized depending on the vehicle 20 that it is to be used with. Thus, a user of the assembly 10 would select one for their vehicle's 20 particular make and model. As such, the first 22 and second 24 side sections will correspond to the first and second sides of the vehicle 20, the top section 26 will correspond to the hood, roof and trunk (if the vehicle has one), the front section 28 will correspond to the front end and the rear section 30 will correspond to the rear end of the vehicle 20.

Each of the first 22 and second 24 side sections has an access door 32 cut into the panel 12 wherein each the access door 32 is formed by a flap portion 34 of the panel 12. The access doors 32 are aligned with the driver and front passenger side doors. Thus, the access doors 32 will allow the user of the assembly to enter either the passenger door or the driver door of the vehicle 30 so that the vehicle 30 may still be operated and be used as protection for the user.

The panel 12 may further have a plurality of window flaps 38 therein cut into the panel 12. The window flaps 38 may include a front window flap 40 positioned in the top side 26 and configured to be aligned with a front window of the vehicle 20 and a rear window flap 42 positioned in the top side 26 and configured to be aligned with a rear window of the vehicle 20. Thus, if the vehicle 20 needs to be moved, the driver of the vehicle can see rearward and forward of the vehicle 20. Furthermore, the window flaps 38 may include a pair of door windows 44 each positioned in one of the access doors 32 and configured to be aligned with windows in respective one of a driver side door and a passenger side door of the vehicle 20. The window flaps 38 may or may not include closures to retain them in place such as conventional hook and loop closures.

A plurality of transparent windows 46 may also be positioned in the panel 12. The transparent windows 46 may be comprised of a flexible plastic. The front section 28 includes a pair of the transparent windows 46 each defining a headlight window and configured to be aligned with headlights of the vehicle 20. The rear section 28 includes a pair of the transparent windows 46 each defining a taillight window and configured to be aligned with taillights of the vehicle 20. Furthermore, each opening formed by the window flaps 38 may also include transparent windows to add some protection to the vehicle 20 windows exposed by the window flaps 38.

A plurality of bladders 48 is positioned between the top 14 and bottom 16 sides of the panel 12. The bladders 48 are elongated and may extend generally from a front to a rear of the panel 12. The bladders 48 are in fluid communication with each other, such as by conduits 50, and are inflatable such that the top side 14 of the panel 12 is spaced from the bottom side 16 a distance of at least 3.0 inches and up to 6.0 inches. The bladders 48 form a series of adjacently positioned tubes 50 when inflated as shown in FIG. 4. The bladders 48 substantially cover an entirety of the panel 12, however, the window flaps 38 and the transparent windows 46 are each is free of the bladders 48 as inflating such areas would prevent their intended usage.

A pump 52 is in fluid communication with the bladders 48. The pump 52 is actuated to fill the bladders 48 with air. The pump 52 is generally conventional and may be fluidly coupled to the bladders 48 with a supply hose 54 that may be non-removably coupled to the panel 12, though a removable supply hose 54 may be used which allows for alternate usages for the pump 52 or other pumps to be used with the assembly. In such a case the pump 52 will include an adapter 56 to fluidly engage a port 58 on the panel 12. The pump 52 may include a vehicle power plug 60 for engaging conventional power ports within the vehicle 20.

A coupler 62 is attached to the panel 12 and is configured to releasably couple the panel to the vehicle 20. The coupler 62 includes at least one strap 64 attached to the perimeter edge 18 of the panel 12. The strap 64 is attached to opposite sides of the panel 12 relative to the vehicle 20 so that the strap 64 extends under the vehicle 20. A buckle 66 or loop may be attached to the perimeter edge 20 to receive the strap 64 and allow its tightening to the vehicle 20. A securing member 68 is used to secure the strap 64 and may comprise a hook and loop coupler.

In use, the panel 12 is positioned on the vehicle 20 and oriented so that the access doors 32 and window flaps 38 are properly aligned with their associated vehicle 20 counterparts. The bladders 48 are then filled with air to inflate them and provide protection from objects, such as hail, from damaging the exterior of the vehicle 20. The access doors 32, window flaps 38 and transparent windows 46 provide the ability to move the vehicle 20 to a safer area if needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle protection system configured for positioning on a vehicle to protect the vehicle from hail, said system including:
a panel comprising a flexible material, said panel having a top side, a bottom side and a perimeter edge, said panel having a size configured to be positioned on a vehicle such that a first side section, a second side section, a top section, a front section and a rear section of said panel are defined;
each of said first and second side sections having an access door cut into said panel wherein each said access door is formed by a flap portion of said panel;
a plurality of bladders being positioned between said top and bottom sides of said panel, said bladders being elongated, substantially tubular, and extending from said front section to said rear section wherein said bladders are configured for extending between a front end and a back end of the vehicle, said bladders being in fluid communication with each other and being inflatable such that said top side of said panel is spaced from said bottom side a distance of at least 3.0 inches, said bladders substantially covering an entirety of said panel; and
a pump being in fluid communication with said bladders, said pump being actuated to fill said bladders with air.

2. The vehicle protection system according to claim 1, wherein said panel has a plurality of window flaps therein cut into said panel, said window flaps including a front window flap positioned in said top side and configured to be aligned with a front window of the vehicle, said window flaps including a rear window flap positioned in said top side and configured to be aligned with a rear window of the vehicle.

3. The vehicle protection system according to claim 2, wherein said window flaps include a pair of door windows each being positioned in one of said access doors and configured to be aligned with windows in respective one of a driver side door and a passenger side door of the vehicle.

4. The vehicle protection system according to claim 1, further including a plurality of transparent windows being positioned in said panel, said front section including a pair of said transparent windows each defining a headlight window and configured to be aligned with headlights of the vehicle.

5. The vehicle protection system according to claim 4, wherein said rear section includes a pair of said transparent windows each defining a taillight window and configured to be aligned with taillights of the vehicle.

6. The vehicle protection system according to claim 1, further including a coupler being attached to said panel and being configured to releasably couple said panel to the vehicle.

7. A vehicle protection system configured for positioning on a vehicle to protect the vehicle from hail, said system including:
a panel comprising a flexible material, said panel having a top side, a bottom side and a perimeter edge, said panel having a size configured to be positioned on a vehicle such that a first side section, a second side section, a top section, a front section and a rear section of said panel are defined;
each of said first and second side sections having an access door cut into said panel wherein each said access door is formed by a flap portion of said panel;
said panel having a plurality of window flaps therein cut into said panel, said window flaps including a front window flap positioned in said top side and configured to be aligned with a front window of the vehicle, said window flaps including a rear window flap positioned in said top side and configured to be aligned with a rear window of the vehicle, said window flaps including a pair of door windows each being positioned in one of said access doors and configured to be aligned with windows in respective one of a driver side door and a passenger side door of the vehicle;
a plurality of transparent windows being positioned in said panel, said front section including a pair of said transparent windows each defining a headlight window and configured to be aligned with headlights of the vehicle, said rear section including a pair of said transparent windows each defining a taillight window and configured to be aligned with taillights of the vehicle;
a plurality of bladders being positioned between said top and bottom sides of said panel, said bladders being elongated, substantially tubular, and extending from said front section to said rear section wherein said bladders are configured for extending between a front end and a back end of the vehicle, said bladders being in fluid communication with each other and being inflatable such that said top side of said panel is spaced from said bottom side a distance of at least 3.0 inches, said bladders substantially covering an entirety of said panel, said window flaps and said transparent windows each being free of said bladders;
a pump being in fluid communication with said bladders, said pump being actuated to fill said bladders with air; and
a coupler being attached to said panel and being configured to releasably couple said panel to the vehicle, said coupler including a strap attached to said peripheral edge of said panel.
